(19) United States
(12) Patent Application Publication
(10) Pub. No.: US 2009/0166444 A1
(43) Pub. Date: Jul. 2, 2009

(54) Method for Attaching a Blower Unit to Industrial Equipment and Apparatus Used Therewith and Methods for Using the Same

(75) Inventor: Edwin Peterson, Brimfield, IL (US)

Correspondence Address: THOMPSON COBURN LLP, ONE US BANK PLAZA, SUITE 3500, ST LOUIS, MO, 63101, US

(73) Assignee: DUST CONTROL TECHNOLOGY INC., Peoria, IL (US)

(21) Appl. No.: 11/966,568

(22) Filed: Dec. 28, 2007

(51) Int. Cl. B05B 17/04; B23P 19/04; F04D 29/00

(52) U.S. Cl. 239/13; 29/700; 416/247 R; 416/146 R

(57) ABSTRACT

A blower unit has a base, a frame extending upward from the base and a fan propelled mister attached to the frame. The fan propelled mister comprises a fan, a discharge tube, and a plurality of nozzles operatively connected to a fluid intake for creating a mist. A rigid frame, mobile engine-powered machine having a lift arm with a mount is provided. An attachment is also provided having a first surface with a coupling portion adapted to secure the attachment to the mount on the lift arm and a second surface with a coupling portion adapted to secure the attachment to the base. The attachment is mounted to the lift arm with the first coupling portion of the first surface, and to the base with the second coupling portion of the second mounting surface. The blower unit and attachment and methods of use of the same are described.

### BACKGROUND

This invention relates generally to methods of attaching a blower unit to industrial equipment, such as construction equipment, and, fixtures used therewith. The disclosure also discussed methods of use of industrial equipment equipped with such a blower unit.

During a variety of work, including but not limited to, construction or demolition work or at coal powered power plants, steel mills, foundries, and other basic industries, a significant amount of dust and other small particles and contaminates is generated and introduced into the surrounding air. Furthermore, when using large machinery such as a backhoe or other excavating equipment, a significant amount of dust and debris is created at or around the point of impact with the ground. Generally speaking, where there is dust, smoke or other contaminants in the air, it is also common for there to be odors. In order to provide a safe working environment as well as inhibit any damage done to the equipment or structures, it is important to try and limit the amount of dust, smoke and odors. Therefore, there is a need to produce a device that provides an effective, portable and easy way to suppress dust, odors and provide cooling for personnel working in such environments.

In the past, attempts have been made to place large fans with misting capability on industrial and construction equipment. For instance, some have fitted a hydraulically activated blower fan on the implement end on construction equipment, such as a Caterpillar 330 Excavator. However, in such a retrofit, the excavator implement is removed and the fan is installed in its place thereby limiting the excavator to a fan/mister to be used in tandem with other excavator equipment. As construction excavators tend to be expensive pieces of capital equipment, this is often not an efficient use of resources. Additionally, a significant amount of structural modification needs to be performed to the implement end of the excavator to allow the implement end to accept the ducted blower fan. In view of the above, what is needed is a efficient way to provide an efficient and portable mechanism to suppress dust, odors and provide cooling for personnel working in such environments, and other useful applications as may be appreciated by those of skill in the art.

### SUMMARY OF THE INVENTION

One aspect of the invention method encompasses a method comprising providing a blower unit comprising a base with a frame extending upward from the base and a fan propelled mister attached to the frame, wherein the fan propelled mister comprises a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source. In accordance with the method, a heavy industry, rigid frame, mobile, engine-powered machine is provided. The machine has a lift arm selectively vertically positionable between raised and lowered positions. The lift arm has an implement on its distal end adapted for remote operation by an operator of the machine, and a mount spaced from the implement. The mount is configured to enable securing an attachment to the lift arm. In accordance with the method, an attachment plate is provided having a first surface with a coupling portion adapted to secure the attachment to the mount on the lift arm and a second surface with a coupling portion adapted to secure the attachment to the base. The method further includes mounting the attachment to the mount of the lift arm with the first coupling portion of the first surface and mounting the attachment to the base with the second coupling portion of the second mounting surface. The method further includes positioning the distal end of the discharge tube generally toward the implement of the distal end of the lift arm, aligning a fluid source to the fluid intake, operating the blower unit to create a mist from the distal end of the discharge tube, and performing operations with the implement while operating the blower unit.

Another aspect of the invention encompasses a method comprising providing a blower unit comprising a base with a frame extending upward from the base and a fan propelled mister attached to the frame, wherein the fan propelled mister comprises a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source. The method further comprises providing a heavy industry, rigid frame, mobile, engine-powered machine having at least two lift arms selectively vertically positionable between raised and lowered positions. The lift arms have a standardized mounting surface adapted for receiving a variety of work implements. The standardized mounting surface is adapted to pivot relative to the lift arms from a remote location within the engine powered machine to position a work implement. The method further includes providing an attachment plate having a first surface with a coupling portion adapted to secure the attachment plate to the standardized mounting surface of the lift arms and a second surface with a coupling portion adapted to secure the attachment to the base. The method further includes mounting the attachment plate to the standardized mounting surface of the lift arm with the first coupling portion of the first surface, and mounting the attachment plate to the base with the second coupling portion of the second mounting surface. The method further comprises moving the lift arm and pivoting the mounting surface to angle the attachment plate in such a manner to position the distal end of the blower unit at a desired location.

Another aspect of the invention is a combination. The combination comprises a blower unit having a base with a frame extending upward from the base and a fan propelled mister attached to the frame. The fan propelled mister comprises a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source. The combination further comprises an attachment plate having a first surface with a coupling portion adapted to secure the attachment to the base and a second surface with a coupling portion adapted to secure the attachment plate to a standardized mount of a lift arm of a heavy industry, rigid frame, mobile, engine-powered machine wherein the lift arm is selectively vertically positionable between raised and lowered positions and the lift arm standardized mount is configured to receive a variety of work implements and enable securing the attachment plate to the lift arm.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the disclosed embodiments and together with the description, serve to explain the principles of the disclosed embodiments. In the drawings:

FIG. 1 is a front perspective view of an embodiment of a blower unit comprising a fan propelled mister for generating high velocity air flow, a base and frame for supporting the fan propelled mister, and a drive for oscillatory movement of the fan propelled mister;

FIG. 2 is a rear perspective vie of an embodiment of the blower unit showing additional detail of the drive;

FIG. 3 illustrates the blower unit of FIG. 1 mounted on a lift arm of construction equipment;

FIG. 4 shows an exploded view of the blower unit of FIG. 1 mounted to a lift arm of a skid steer;

FIG. 5 shows an alternate embodiment of the blower unit of FIG. 1 mounted to an attachment member and a road worthy trailer.

FIG. 6 shows an alternate attachment comprising a three point hitch for mounting the blower unit to a tractor or a like rigid frame, engine driven machine; and

FIGS. 7A-7E show exemplary operations using the blower unit attached to a skid steer.

### DETAILED DESCRIPTION OF THE PREFERRED EMBODIMENT

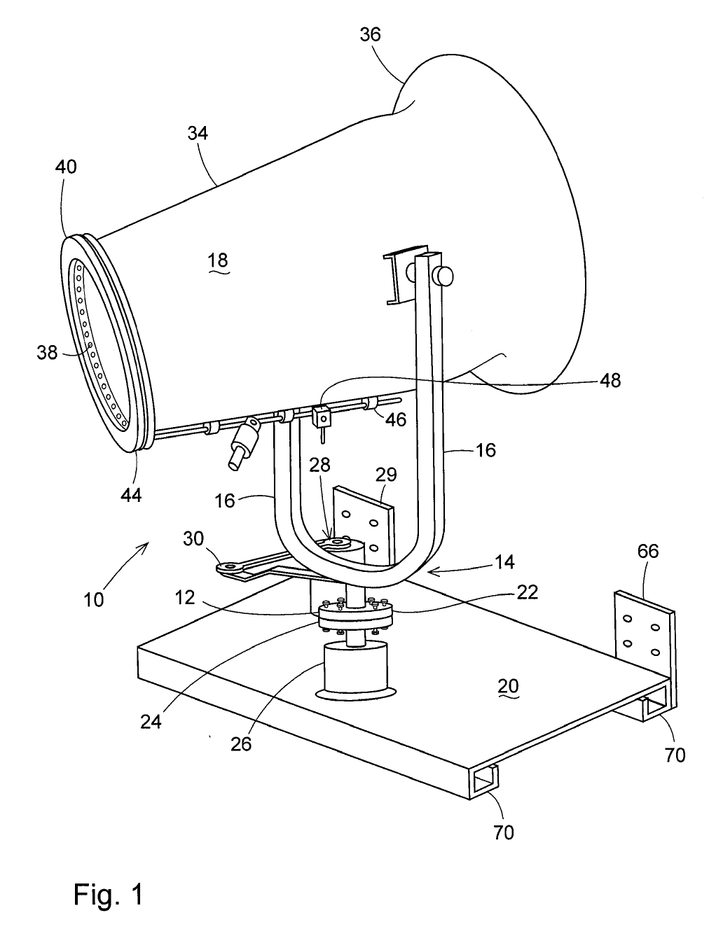

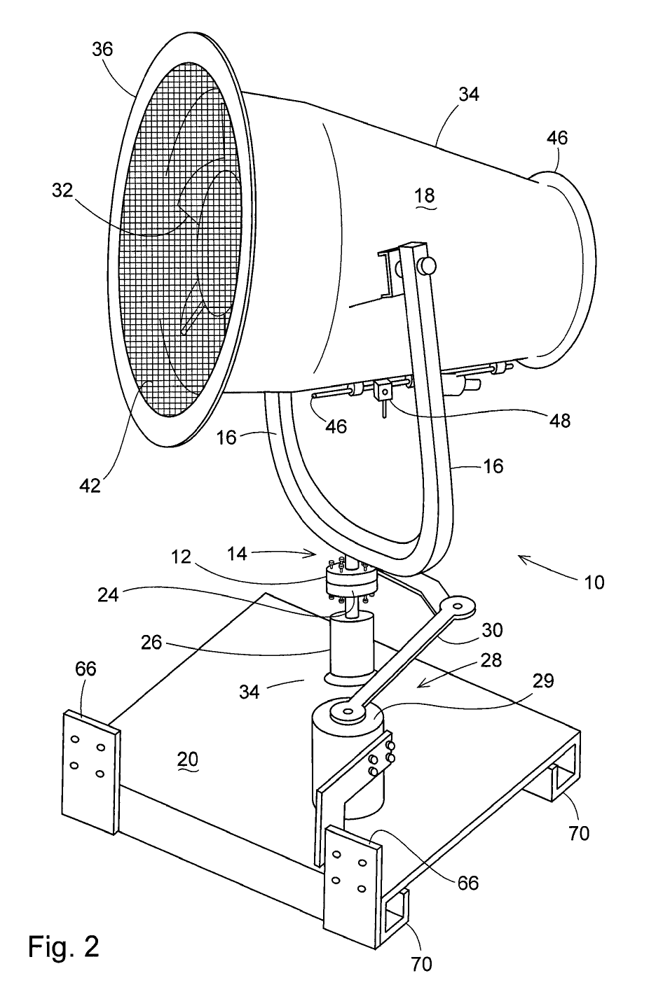

Referring to the accompanying drawings in which like reference numbers indicate like elements, FIGS. 1 and 2 illustrate the general arrangement of the blower unit 20. The blower unit 10 has a base 12 with a frame 14 comprising two arms 16 that extend upward from the base for supporting a fan propelled mister 18 therebetween. The blower unit is supported on an attachment member 20 which is a generally rectangular planar support plate with sufficient rigidity to support the fan propelled mister 18. The base 12 has a coupling portion 22 that secures the base to a connector 24 of a bearing housing 26 that projects from the attachment member to enable oscillation of the base and frame about the attachment member.

The blower unit may have a base drive 28 to provide oscillatory movement of the fan propelled mister (left and right movement in FIGS. 1 and 2). The frame may have actuators located in the arms (not shown) to provide rotary movement of the fan propelled mister (up and down movement in FIGS. 1 and 2). The base drive 28 may comprise a motor 29 and linkages 30 or comprise a system of pneumatic or hydraulic cylinders that extend and retract to produce pivoting motion between the frame and the base. The frame drive may be motor driven or comprise a system of pneumatic or hydraulic cylinders that extend and retract to produce rotary motion of the fan propelled mister. However, as will become evident from the discussion that follows, oscillation and rotation are not necessarily needed as the blower unit may be mounted to equipment capable of performing the desired motions.

The fan propelled mister 18 comprises a fan 32 disposed in a discharge tube 34 located at a proximate end 36 of the discharge tube. With the fan rotating in the forward direction, outside air may be drawn in at the proximate end of the discharge tube by blades of the fan and passed through the discharge tube, where it may be mixed with water injected from nozzles 38 prior to discharge from a distal end 40 of a discharge tube. The fan may also operate in reverse. A debris filter 42, such as a screen or similar structure, is preferably employed to cover the proximate end of the discharge tube. Various motor and fan combinations may also be utilized to assist in regulating the air flow output of the fan propelled mister, and it should be realized that the fan may utilize a hydraulic motor or a motor powered by electricity, gasoline, diesel, propane, or numerous other fuels or other power supplies.

As described in applicant's application Ser. No. 11/383,293, currently pending, the fan propelled mister may have a misting ring 44 with a plurality of nozzles adjacent the distal end 40 of the discharge tube to create a mist of small fluid particles. The nozzles may be sized to create small fluid particles that control and or suppress dust and/or suppressing odor, and to vary water flow rates. Different sized nozzles may be provided in the misting ring for each purpose. For instance, the differently sized nozzles may be alternated or otherwise located in a single ring or on concentric rings—one size to control dust and a different size to control odors. The different sized nozzles may be removable from the rings to allow replacement or to provide the operator with the ability to configure the fan propelled mister as required by a specific dust suppression operation or odor suppression operation. Nozzles may also be installed that allow the fan propelled mister to spray water without the operation of the fan.

A fluid such as water is preferably supplied to the misting ring through a fluid intake 46 that is connected to a fluid source such as a water tank or outlet (not shown). Agents may be added to the water to assist in odor or dust suppression. A hose (not shown) may be used to supply water from the fluid source to the fluid intake. The fluid intake may have simple on/off valves 48 to control the supply of water and to select which set, or sets of nozzles are activated. Water flow to the fluid intake and nozzle sets may also be controlled through solenoid valves, or similar other devices.

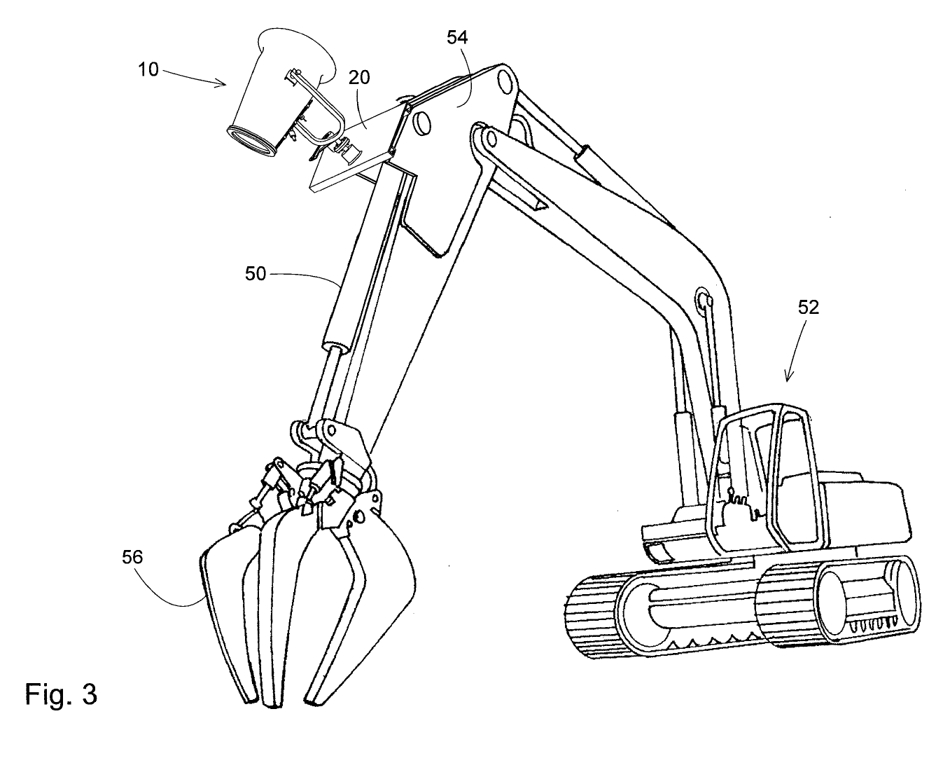

FIG. 3 shows a configuration where the blower unit 10 is mounted on a lift arm 50 of heavy construction equipment 52. In this arrangement, the attachment member is mounted to structural support members 54 located on the lift arm such that that blower unit is aimed directly at an implement 56 operating at a work site, although the fan propelled mister may also be permitted to oscillate to spread the airflow and mist over a larger area. Preferably, operation of the blower unit is controlled remotely from the cab of the construction equipment, and the power systems resident on the construction equipment may be integrated with and used to operate the blower unit. For instance, a hydraulic system used to power the fan and produce oscillation of the base and the frame and rotation of the fan propelled mister may be integrated with the hydraulic systems onboard the construction equipment. In an alternative embodiment, power for the base drive, frame drive, fan, and water valves may be supplied from an independent generator having its own power source. The independent generator may be located on the construction equipment in a position that does not interfere with the operation of the equipment. Water for the misting operation may be supplied from a water tank carried on board the construction equipment or an independent supply located in an area that does not interfere with the operation of the equipment.

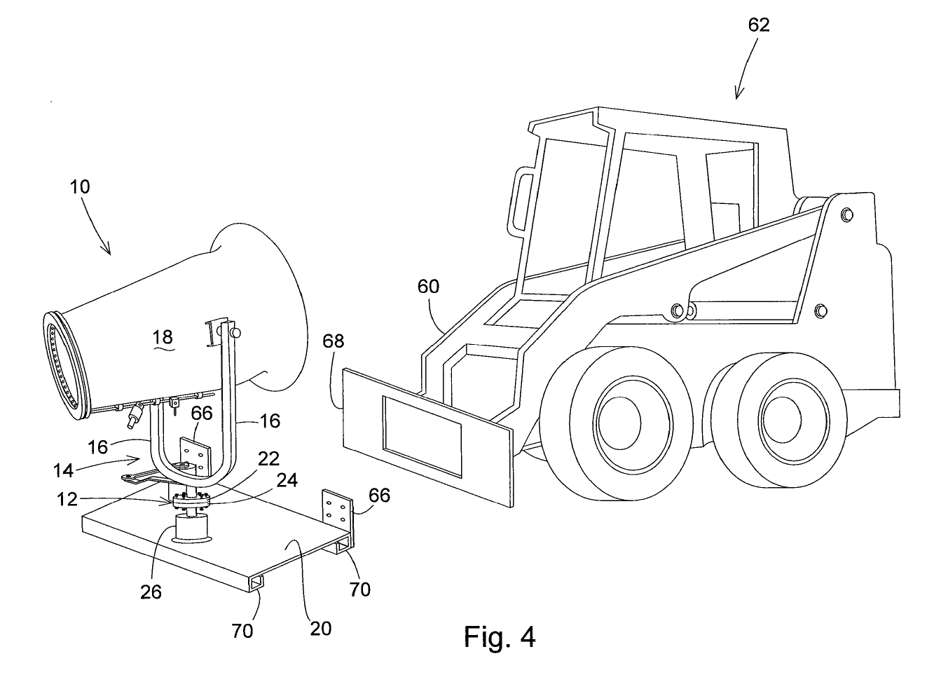

FIG. 4 illustrates an alternate embodiment where the blower unit 10 is mounted on the lift arm 60 of a skid steer 62. The attachment 20 has coupling portions 66 that enable the attachment to be mounted to the bifurcated lift arm of the skid steer. The first coupling portions 66 of attachment 20 may be provided in a standardized arrangement to allow its use with a variety of makes and models of skid steers, and skid steers equipped with or without mounting plates. A skid steer mounting plate 68 is shown in FIG. 4, but the first coupling portions of the attachment may be configured to attach directly to the skid steer arms. The coupling portions may be welded to the mounting plate, releasably fastened, or secured with mechanical fasteners. A kit of fasteners and instructions may be provided to increase flexibility of use of the blower unit with a variety of makes and models of skid steers. The attachment is also preferably provided with channels 70 extending generally along its side to receive forks, for instance forks of a fork lift or a skid steer so equipped. In the embodiment shown in FIG. 4, a power supply on-board the skid steer may be used to power the blower unit. Because a skid steer is relatively mobile, the blower unit may be simplified to eliminate a base drive and a frame drive, and the lift arm motion and drives of the skid steer may be used to direct the discharge of the fan-propelled mister to a desired location.

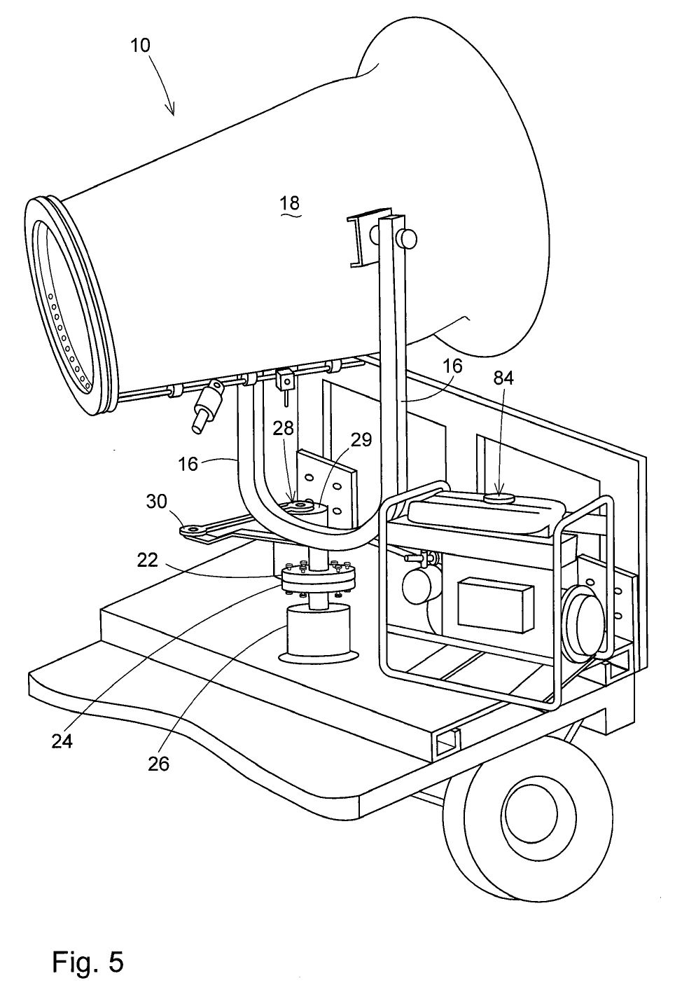

FIG. 5 illustrates an alternative embodiment where the blower unit 10 is mounted to an attachment 80 supporting a generator 84 of the blower unit. The attachment 80 may comprise a road worthy trailer allowing the blower unit to be transported to via a conventional hitch. The generator 84 may produce electricity or provide hydraulic power, or comprise another power supply, depending on the power requirements of the blower unit and the fan-propelled mister. The generator may have an onboard fuel or power supply thereby allowing its operation independent of the skid steer.

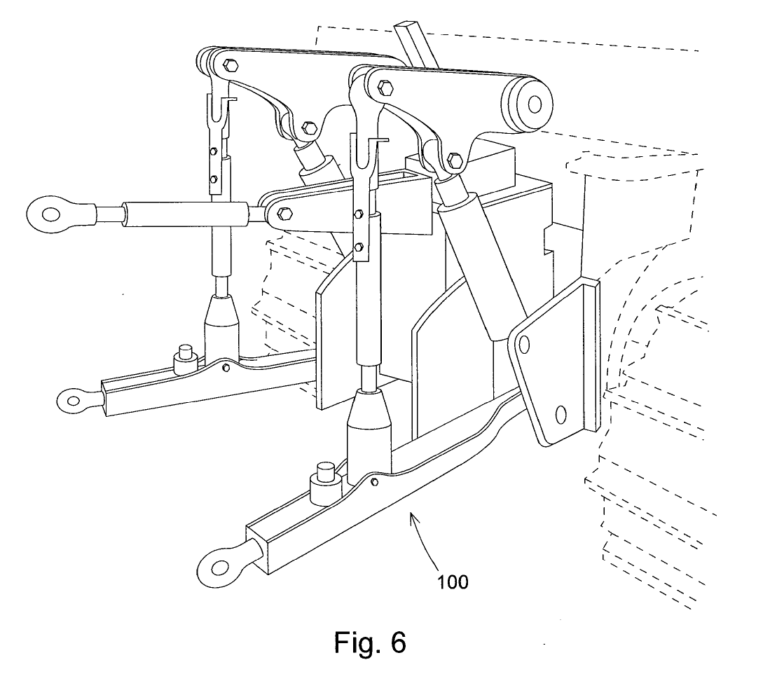

FIG. 6 shows an alternate embodiment where the blower unit may be mounted to a three point hitch 100 of a tractor, either directly to the rear plate 74 of the base of the blower as described above in reference to FIG. 4, or with an mounting plate 68 as described above in FIG. 4 modified for mounting to a three point hitch.

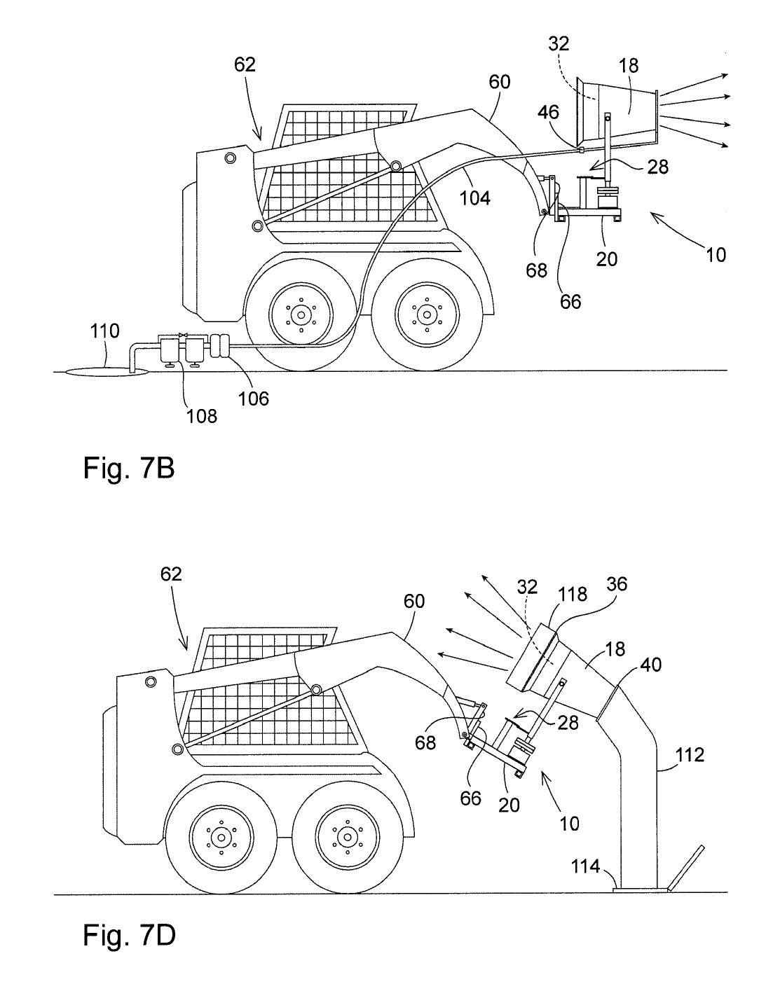

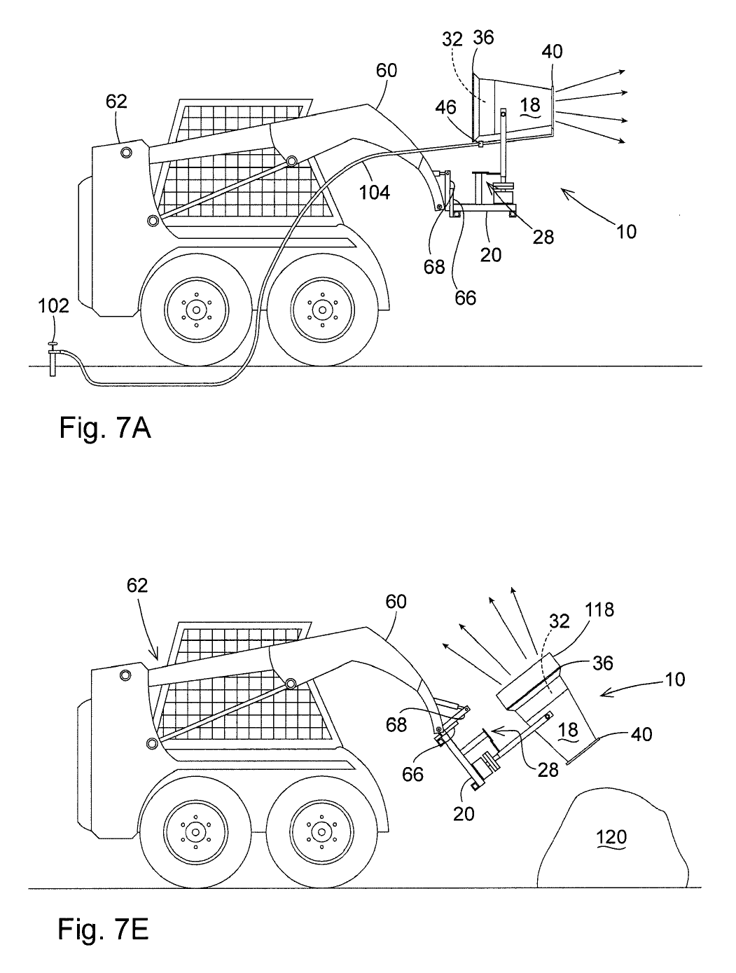

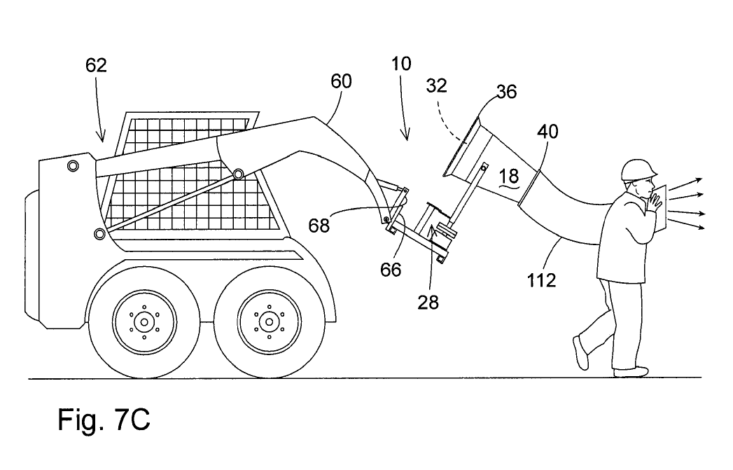

With the blower unit attached to the skid steer, or other similar type of rigid frame, engine driven machine, one may use the blower unit for a variety of operations as shown in FIGS. 7A-7E. As described above, the fluid intake 46 on the fan propelled mister 18 may be operatively connected to a water supply 102 with a hose 104 to generate a high velocity fluid mist for suppressing dust and odors as shown in FIG. 7A. The high velocity fluid mist may also be used for cooling, such as cooling vegetation or personnel operating on a worksite, or for creating snow.

A blower unit as described above may also be modified for dewatering operations, as shown in FIG. 7B. For instance, a dewatering pump 106 and filter assembly 108 may be aligned with the fluid intake 46 of the fan propelled mister 18. By operating the blower unit 10 and the dewatering pump 106 tandem, water may be drawn from undesirable areas 110, filtered, and introduced to the fluid intake of the blower unit to be expelled via the discharge tube in a fine mist that can be evaporated.

In other operations and applications, the blower unit need not be connected to a fluid source. The fan 32 of the blower unit 10 may be operated as a high velocity blower for operations such as leaf, debris, and snow removal. For instance, hose attachments 112 may be provided on the distal end 40 of the discharge tube 34 of the blower to direct the high velocity flow as required for leaf, debris and/or snow removal as shown in FIG. 7C. The fan 32 of the blower unit 10 may also be operated in reverse so the blower unit may function as an exhaust fan to push or pull air from voids or spaces. For instance, the distal end 40 of the discharge tube 34 may have a hose attachment 112 directed into a manhole 114 and the fan 32 operated in reverse to draw air from the manhole through the distal end of the discharge tube to be expelled from the proximate end 36 of the discharge tube 34 as shown in FIG. 7D. A hose (not shown) may be mounted to the proximate end of the discharge tube to direct exhaust as needed. A filter medium 118 may also be attached to the proximate end 36 of the discharge tube (i.e., the discharge end when the fan operates in reverse) to assist in the collection and control of dust 120, or to filter exhaust as shown in FIG. 7E.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method comprising:
providing a blower unit comprising a base with a frame extending upward from the base and a fan propelled mister attached to the frame, wherein the fan propelled mister comprises a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source;
providing a heavy industry, rigid frame, mobile, engine-powered machine having a lift arm selectively vertically positionable between raised and lowered positions, the lift arm having an implement on its distal end adapted for remote operation by an operator of the machine, and a mount spaced from the implement, the mount configured to enable securing an attachment to the lift arm;
providing an attachment plate having a first surface with a coupling portion adapted to secure the attachment to the mount on the lift arm and a second surface with a coupling portion adapted to secure the attachment to the base,
mounting the attachment plate to the mount of the lift arm with the first coupling portion of the first surface;
mounting the attachment plate to the base with the second coupling portion of the second mounting surface; and
positioning the distal end of the discharge tube generally toward the implement of the distal end of the lift arm;
aligning a fluid source to the fluid intake;
operating the blower unit to create a mist from the distal end of the discharge tube; and
performing operations with the implement while operating the blower unit.

2. A method comprising:
providing a blower unit comprising a base with a frame extending upward from the base and a fan propelled mister attached to the frame, wherein the fan propelled mister comprises a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source;
providing a heavy industry, rigid frame, mobile, engine-powered machine having at least two lift arms selectively vertically positionable between raised and lowered positions, the lift arms having a standardized mounting surface adapted for receiving a variety of work implements, the mounting surface being adapted to pivot relative to the lift arms from a remote location within the engine powered machine to position a work implement;
providing an attachment plate having a first surface with a coupling portion adapted to secure the attachment plate to the standardized mounting surface of the lift arms and a second surface with a coupling portion adapted to secure the attachment to the base;
mounting the attachment plate to the standardized mounting surface of the lift arm with the first coupling portion of the first surface; and
mounting the attachment plate to the base with the second coupling portion of the second mounting surface;
moving the lift arm and pivoting the mounting surface to angle the attachment plate in such a manner to position the distal end of the blower unit at a desired location.

3. The method of claim 2, further comprising releasably securing the first surface coupling portion to mounting surface of the lift arms.

4. The method of claim 2, wherein the first coupling portion comprises spaced apart channels extending generally along sides of the attachment.

5. The method of claim 2, further comprising providing a drive on the attachment for producing oscillation of the blower unit about the attachment.

6. The method of claim 5, further comprising aligning hydraulics associated with the machine to the drive.

7. The method of claim 2, further comprising aligning hydraulics associated with the machine to the blower unit to operatively rotate the fan.

8. The method of claim 2, wherein the first surface coupling portions are arranged in a standardized pattern.

9. The method of claim 2, wherein the first surface coupling portion is configured to connect to a three point adapter.

10. The method of claim 2, further compromising aligning a pump discharge to the fluid intake.

11. The method of claim 2, further comprising aligning a fluid source to the fluid intake.

12. The method of claim 11, further compromising creating a cooling mist.

13. The method of claim 11, further compromising suppressing at least one or dust and odors.

14. The method of claim 11, further compromising creating snow.

15. The method of claim 2 further comprising installing at least one of a hose and a filter media on a discharge of the fan propeller mister.

16. A combination comprising:
a blower unit having a base with a frame extending upward from the base and a fan propelled mister attached to the frame, the fan propelled mister comprising a fan for drawing air into the fan propelled mister, a discharge tube for creating a high velocity airflow exiting from a distal end of the discharge tube, and a plurality of nozzles operatively connected to a fluid intake and located proximate the distal end of the discharge tube for creating a mist when placed in communication with a fluid source; and
an attachment plate having a first surface with a coupling portion adapted to secure the attachment to the base and a second surface with a coupling portion adapted to secure the attachment to a standardized mount of a lift arm of a heavy industry, rigid frame, mobile, engine-powered machine wherein the lift arm is selectively vertically positionable between raised and lowered positions and the lift arm mount is configured to enable securing the attachment to the lift arm.

17. The combination of claim 16, further comprising a power generator on the attachment for operating the blower unit.

18. The combination of claim 16, wherein the second surface coupling portions are arranged in a standardized pattern.

19. The combination of claim 16, wherein the second surface coupling portions are adapted to be secured to a three point adapter.

20. The combination of claim 16, further comprising channels on the attachment adapted to receive forks of a fork lift.

21. The combination of claim 16, wherein the second surface coupling portions are adapted to be secured to lift arms of a skid steer.

22. The combination of claim 16, further comprising a filter media attachable to a discharge of the fan.

23. The combination of claim 16, further comprising a hose attachable to a discharge of the fan.

24. The combination of claim 16, further comprising a drive on the attachment for oscillating the blower unit on the attachment.
